(19) United States
(12) Patent Application Publication
(10) Pub. No.: US 2013/0024205 A1
(43) Pub. Date: Jan. 24, 2013

(54) DYNAMICALLY UPDATING ELECTRONIC MEDICAL RECORDS AND LEVERAGING A PERSON'S PATH IN A FACILITY TO MITGATE RISKS

(71) Applicants: Ruthie D. Lyle, Durham, NC (US); Cynthia E. Barber-Mingo, Westford, MA (US); Angela Richards Jones, Durham, NC (US); David B. Lection, Raleigh, NC (US)

(72) Inventors: Ruthie D. Lyle, Durham, NC (US); Cynthia E. Barber-Mingo, Westford, MA (US); Angela Richards Jones, Durham, NC (US); David B. Lection, Raleigh, NC (US)

(73) Assignee: International Business Machines Corporation, Armonk, NY (US)

(21) Appl. No.: 13/185,072

(22) Filed: Jul. 18, 2011

(51) Int. Cl. G06Q 50/00

(52) U.S. Cl. 705/3

(57) ABSTRACT

Automatically updating an electronic medical record in response to an exposure to a communicable disease is disclosed. A system receives data indicating a common reference point of exchange for a first person and for a second person. The system further detects an update to an electronic medical record of the first person where the update includes a diagnosis of a communicable disease. The data indicating the common reference point and the communicable disease is used to determine an exposure of the second person to the communicable disease. Upon determining such exposure, an electronic medical record for the second person is updated to reflect the exposure to the disease.

### BACKGROUND

Embodiments of the inventive subject matter generally relate to the field of computer systems, and, more particularly, to dynamically updating electronic medical records based on a location in a medical facility.

Individuals typically have encounters with health care facilities numerous times, whether seeking health care for themselves, accompanying others seeking health care, or visiting someone receiving health care. An unfortunate consequence of visits to health care facilities is that persons may be exposed to communicable diseases carried by other persons at the health care facility. The problem is particularly troublesome at hospitals, which often experience large numbers of people entering and leaving at any particular time.

### SUMMARY

Some embodiments include a method for automatically updating an electronic medical record. The method includes receiving data indicating a common reference point of exchange for a first person and for a second person. The method further includes detecting an update to an electronic medical record of the first person where the update includes a diagnosis of a communicable disease. The data indicating the common reference point and the communicable disease is used to determine an exposure of the second person to the communicable disease. Upon determining such exposure, an electronic medical record for the second person is updated to reflect the exposure to the disease.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example system for dynamically updating electronic medical records.

FIG. 2 depicts a flowchart of an example method for dynamically updating electronic medical records.

FIG. 3 depicts a flowchart of an example method for performing actions based on a person's path through a medical facility.

FIG. 4 depicts an example computer system.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

In general, the embodiments receive common reference points of exchange for two or more persons. In the event that a person is diagnosed with a communicable disease, the embodiments can use the common reference points of exchange to determine who has been potentially exposed to the communicable disease and to automatically update EMRs (Electronic Medical Records) for the affected people.

In addition, the common reference point of exchange for a person having a communicable disease may comprise a path in a medical facility. The embodiments described below determine actions to be performed that can be used to mitigate the risk that others will contract the communicable disease.

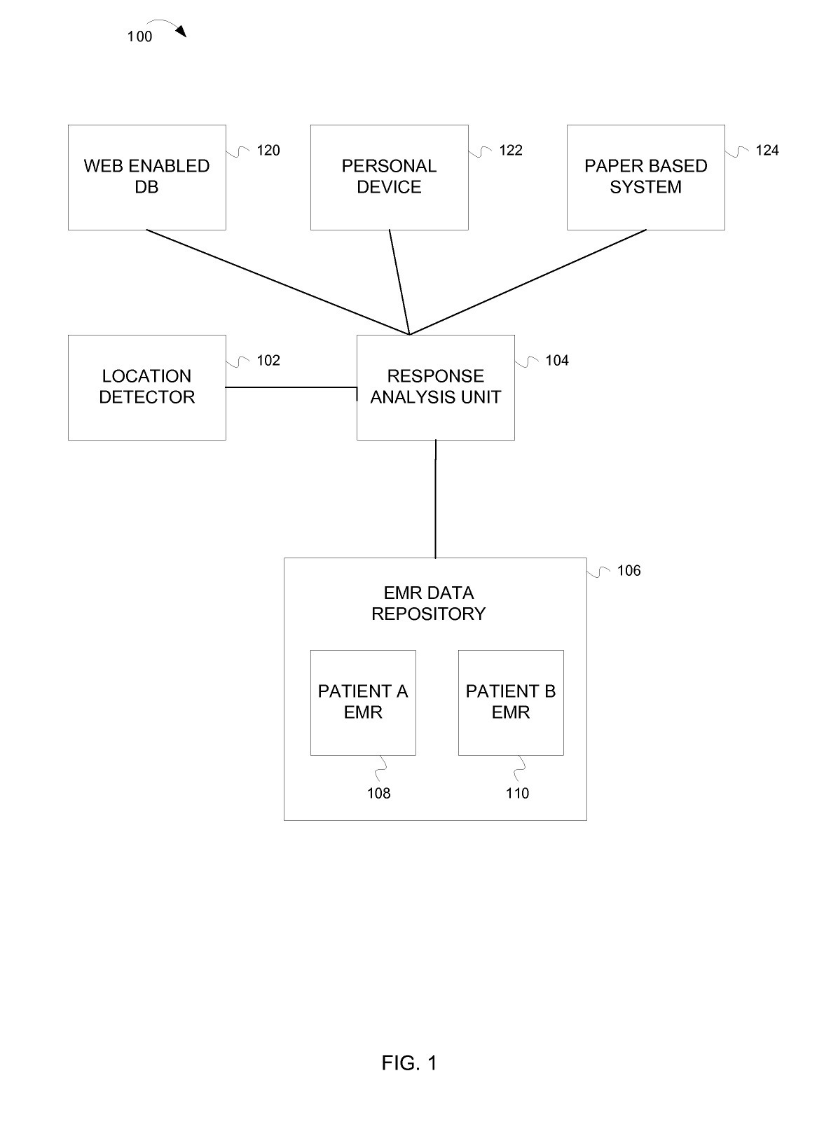

FIG. 1 depicts an example system 100 for dynamically updating electronic medical records. In some embodiments, system 100 includes a location detector 102, response analysis unit 104 and an EMR (Electronic Medical Records) database 106.

Location detector 102 detects and optionally tracks the location of persons in a medical facility. Various mechanisms for detecting and tracking location may be used in various embodiments. For instance, an RFID (Radio Frequency Identification) tag may be provided to a person. As an example, the RFID tag may be embedded in a card or bracelet provided to a patient when the patient enters a medical facility. RFID readers may be located throughout the medical facility to read the RFID tags and determine a location based on the location of the RFID tag reader. In alternative embodiments, the location detector may determine the location of a person by detecting the location based on a signal provided from the person's mobile phone or other device carried by the user. Video tracking systems that can identify and track persons in the video may be used in further alternative embodiments. Any mechanism capable of providing a location of a person that is now known or developed in the future may be used by location detector 102 to detect the location of persons in a medical facility.

EMR data repository 106 is a data repository that stores electronic medical records 108. An EMR 108 comprises one or more data structures that include data relevant to the medical history of a patient. An EMR 108 may be created and maintained by an EMR system used by a health care facility such as a clinic or hospital. Further, an EMR may be created and maintained by a patient using a personal EMR system. EMR data may include data identifying the patient, test results, diagnoses, practitioner notes, treatments and other data related to the health or medical history of a patient. Although illustrated as a single repository in FIG. 1, EMR data repository 106 may be a repository that is distributed across multiple systems. Further, the system may access multiple EMR repositories containing EMR records.

Response analysis unit 104 receives data provided by location detector 102 and EMR database 106 and uses the data to determine actions that may be appropriate to mitigate risks to patients, employees, visitors, and other occupants of a medical facility based on exposure to a communicable disease.

In some embodiments, RFID tags such as the tags used to detect location may also receive information. For example, in some embodiments, RFID tags receive exposure information and recommendation for treatment from response analysis unit 102.

System 100 optionally includes web enabled database 120 accessible to patients and response analysis unit 102. In some embodiments, web enabled database receives information and notifications from response analysis unit 102. Patients can receive the information and notifications through web enabled database 120.

System 100, in some embodiments, communicates with a personal device 122. Personal device 122 may be a mobile phone, personal digital assistant, music player, tablet computer etc. that can be carried by a user. The personal device may provide location data to a response analysis unit 102 through an on-board GPS unit. Further, the personal device may communicate with response analysis unit 102 to receive and transmit exposure information or risk information related to exposure to a communicable disease.

In some embodiments, response analysis unit 102 provides paper printouts or tracking reports that can be updated in a paper based system 124 such as a physical health “pass book.” The reports or printouts may be mailed to patients who were in the hospital, but do not use electronic mechanisms to receive information.

Further details on the operation of the above-described system are provided below.

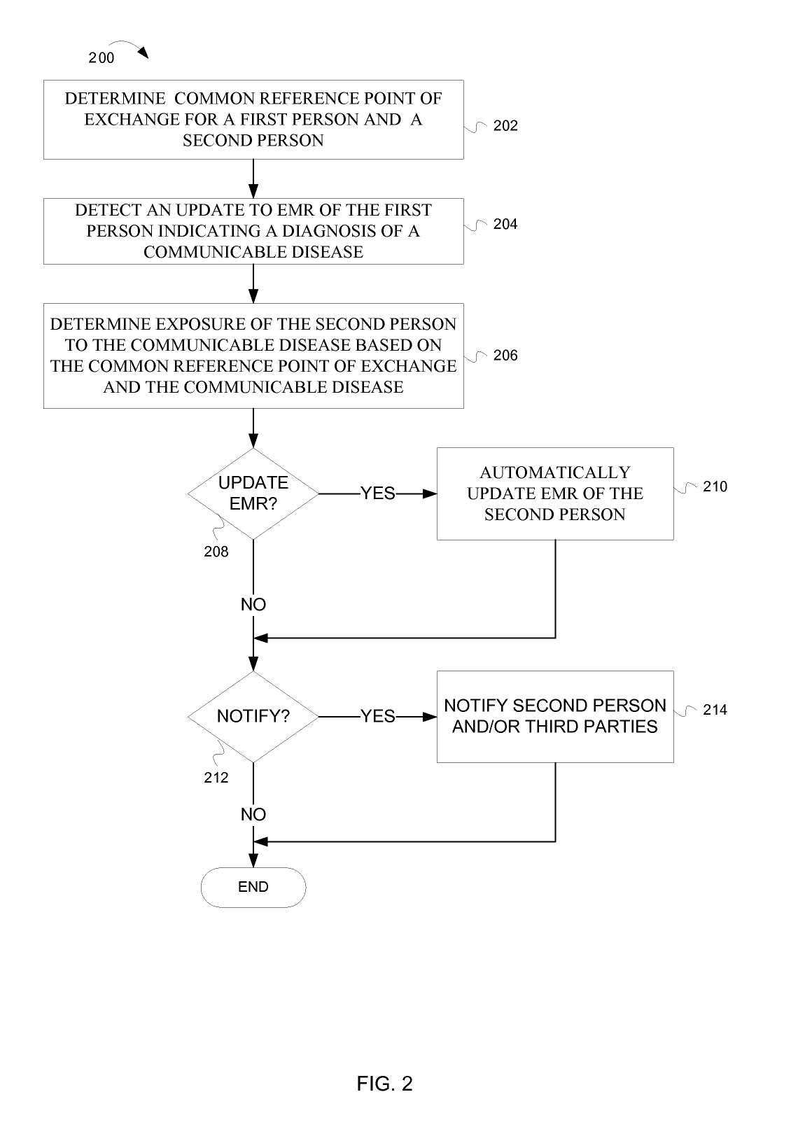

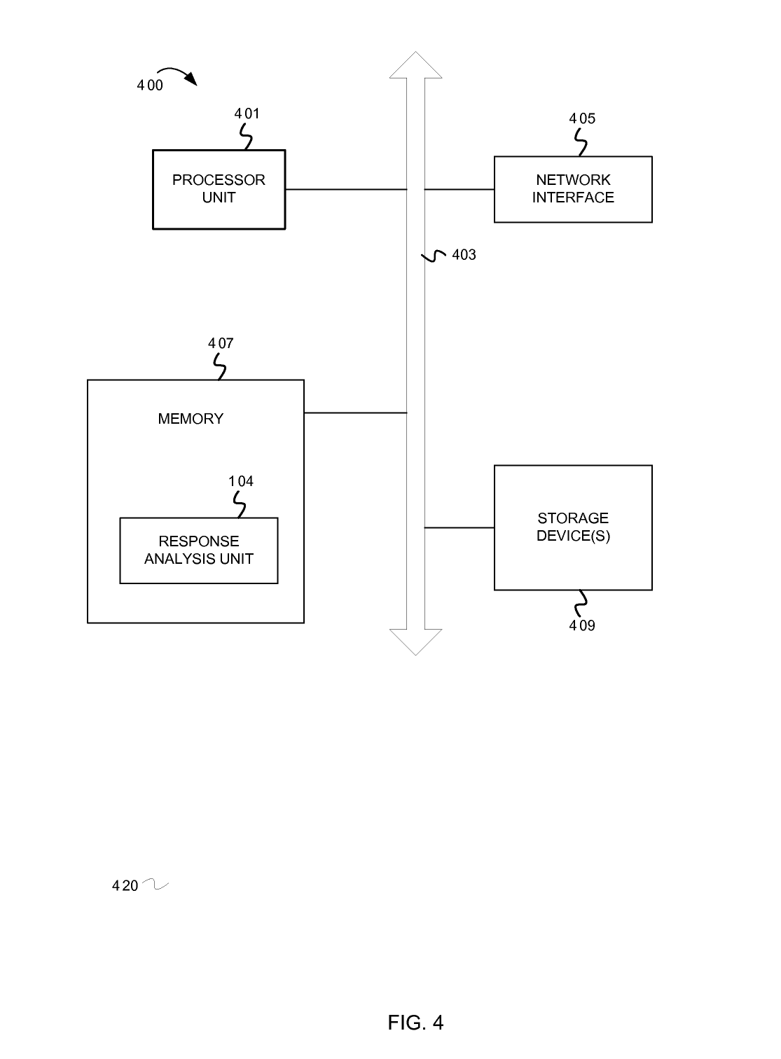

FIG. 2 depicts a flowchart of an example method 200 for dynamically updating electronic medical records. For example purposes, operations associated with the blocks in FIG. 2 will be described as being performed by an EMR update system (“system”), which may, for example, include any or all of the elements described in FIG. 1 or 4. FIG. 2 illustrates a flow 200 that the system can perform.

The method begins at block 202 with the system receiving data indicating a common reference point of exchange for a first person and a second person. The common reference point of exchange may be a location of the first person and the second person. As described above, the system may determine a person's location using various forms of location detection. For example, the system may employ video tracking, RFID tracking, or tracking signals of mobile phones or other devices carried by a user to determine locations of persons in a medical facility. The system may also time-stamp the location data to indicate the date and time that the person was at a particular location.

Other examples of common reference points of exchange include objects handled by the first person and the second person or vehicles (planes, trains, cars etc.) occupied by the first person and the second person. A common reference point of exchange may be a third person. For example, patient A may have contact with hospital employee B, who then has contact with patient C. In this example, hospital employee B is a common reference point of exchange with respect to patients A and C.

At block 204, the response analysis unit 104 detects an update to an EMR of the first person that indicates the first person has (or had) a communicable disease. For example, the communicable disease may be a treatable virus or bacterial infection. The update may be an update that provides a test result that indicates the first person has a communicable disease. Alternatively, the update may be the result of a diagnosis by a medical professional that the first person has a communicable disease. The response analysis unit 104 may detect the update various ways. For example, in some embodiments, a trigger or stored procedure in EMR data repository 106 is configured to send a notification of updates to EMRs to response analysis unit 104. In alternative embodiments, software in a medical facility that provides a user interface for updating EMRs or software that provides a user interface for a patient to update their own EMRs is configured to send an electronic notification of the update to response analysis unit 104. In further alternative embodiments, response analysis unit 104 is configured to analyze transaction logs of activity in EMR data repository 106.

At block 206, the response analysis unit 104 determines if a second person has been exposed to the communicable disease. The response analysis unit can utilize one or more factors when determining that a second person has been exposed to the communicable disease. For example, the location data of the first person and the second person can be used to determine proximity of the first person having the communicable disease to the second person. The response analysis unit 104 can then determine if the proximity is within a range where transmission of the communicable disease from the first person to the second person is possible. In some embodiments, the range may be determined by a health care facility. Further, the range may be determined by the second person. For example, the second person may indicate in their EMR that they would like to be notified if they come within a particular range of a person having a communicable disease. The response analysis unit 104 may use the transmission medium of the communicable disease to determine the range. For example, if direct contact is required in order for the communicable disease to be passed to another person, then the range may be less than the range for a communicable disease that can be transmitted through the air.

In some embodiments the response analysis unit 104 uses incubation periods to determine if the second person has been exposed to a communicable disease. For example, assume that a communicable disease has an incubation period of three days. The response analysis unit 104 may determine that a second person has been exposed to the communicable disease when the second person is in the same location as a first person having a communicable disease if the second person was within a particular range of the location within three days of the first person having been at the location.

It should be noted that the determination of exposure can be both forward tracked and backward tracked. For example, the response analysis unit 104 can track exposure by other people after a diagnosis of a communicable disease of a first person (forward tracking) and used to update EMRs of the affected persons. In addition, the response analysis unit 104 can track exposure by other people that were in an area of a first person prior to the diagnoses of a communicable disease (backward tracking) In either case, the response analysis unit 104 uses the exposure information to update EMRs of the affected persons.

At block 208, the response analysis unit 104 determines if the EMR of the second person is to be updated. In some embodiments, the response analysis unit 104 uses a severity factor of the communicable disease to determine if the EMR of the second person is to be updated. For example, if the communicable disease is the common cold and thus has a low severity, the response analysis unit 104 may determine that the second person's EMR does not need to be updated. Alternatively, if the communicable disease is the Ebola virus and thus has a high severity, the response analysis unit 104 determines that the second person's EMR is to be updated.

In some embodiments, the response analysis unit 104 uses data from the second person's EMR to determine if the second person's EMR is to be updated. For example, assume that the communicable disease is one that generally only affects patients with a compromised immune system. Further assume that the response analysis unit 104 has determined that patients A and B have been exposed to the communicable disease through patient C. Finally, assume that patient A's EMR indicates that patient A has a compromised immune system and that patient B's EMR does not have any indication that patient B's immune system is compromised. The response analysis unit 104 may then utilize the information to determine that patient A's EMR is to be updated regarding the exposure to the communicable disease and determine that patient B's EMR is not to be updated.

If the check at block 208 determines that the second person's EMR is to be updated, then at block 210, the response analysis unit 104 updates the EMR. The update may include data indicating the type of disease that the second person has been exposed to. In addition, the update may include data indicating the source of the exposure. The source of the exposure may include one or more of the location of the exposure, the time of the exposure, and the person that was the source of the exposure. The response analysis unit 104 may anonymize the identity of the person that was the source of the exposure in order to comply with privacy policies or regulations such as HIPAA (Health Insurance Portability and Accountability Act).

At block 212, the response analysis unit 104 determines if a notification is to be provided regarding the exposure. The notification can be instead of, or in addition to, the update of the second person's EMR described above. Again, the response analysis unit 104 can use various factors to determine whether a notification is to be made, including the severity of the communicable disease, data from the first or second person's EMR, the type of communicable disease etc.

If the check at block 212 determines that a notification is to be provided, then at block 214, the response analysis unit 104 provides a notification. The notification can be electronic (e.g., email or electronic message) or written (e.g., a mailing). The notification can be one or more of various types of notifications. The response analysis unit 104 may send a notification of the exposure to the second person. The notification may include information or references to sources of information about the communicable disease. The notification may provide treatment options for the disease. The treatment options in the notification may vary depending on the time that has passed from the exposure to when the notification is provided. Additionally the notification may provide different treatment options that vary depending on when, in the future, the user may decide to seek treatment. For example, the treatment may vary depending on whether the receiver seeks immediate treatment or whether the user seeks treatment a week from receiving the notification. In addition to providing information regarding the exposure to the second person, the notification can provide a voucher, coupon or other discount for a medication that may be effective in treating the communicable disease.

Additionally, the response analysis unit 104 may provide a notification of the second person's exposure to the communicable disease to the second person's health care provider(s) or the medical facility in which the exposure occurred. The notification may include a recommendation for a prescription, which can be automatically generated and sent to the second person upon approval of the health care provider. Alternatively, the prescription may be automatically sent to a pharmacy at the health care facility or to a pharmacy convenient to, or preferred by, the second person.

Further, the response analysis unit 104 may send a notification to an insurance company providing insurance to the second person. The insurance company may then follow up with the second person to advise the second person about treatments or medications that may be used to prevent the communicable disease or lessen the effects of the communicable disease.

Additionally, the response analysis unit 104 may schedule appointments for future treatments or follow-up examinations and provide notifications of the appointment dates and times to the second person.

As can be seen from the above, the updates to the second person's EMR and the notifications provided to the second person can be customized based on the data in the second person's EMR. Further, the updates or notifications can be customized based on user preferences.

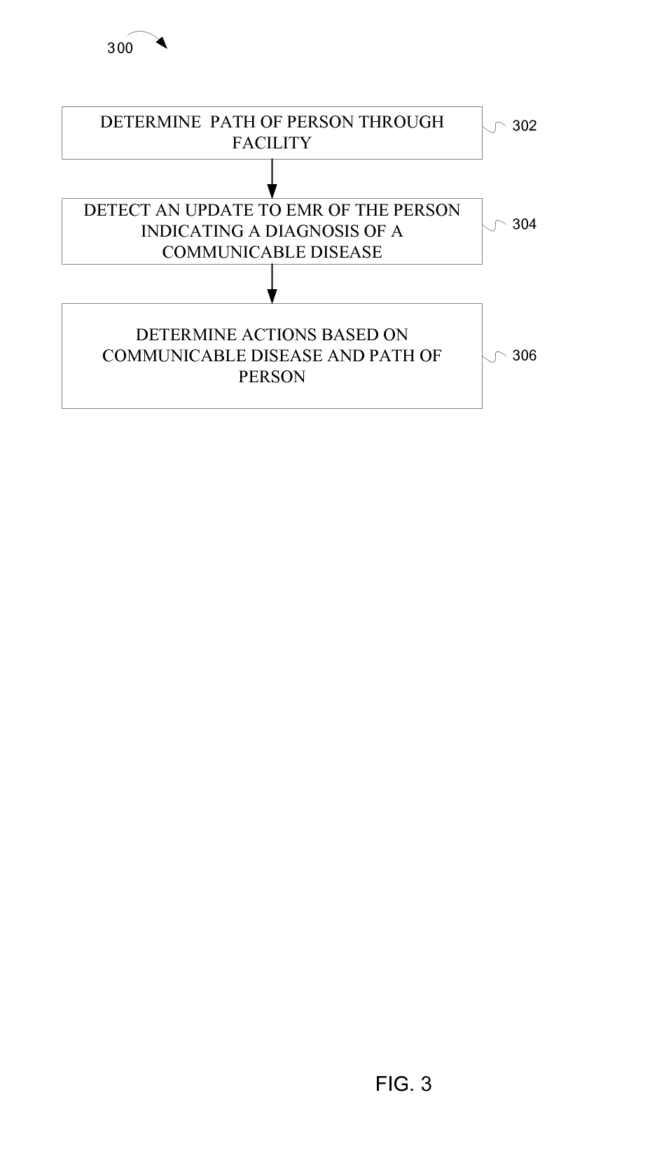

FIG. 3 depicts a flowchart of an example method for performing actions based on a person's path through a medical facility. At block 302, the system determines the path of a person in a medical facility. In some embodiments, location detector 102 determines the path and using data gathered by location detector 102. In alternative embodiments, response analysis unit 104 determines that path using data provided by location detector 102. As described above, the location can be determined through RFID tags and readers, signals received from a mobile phone or other device carried by the person, or other mechanisms that can provide location data for a person.

At block 304, response analysis unit 104 detects an update to an EMR of the person indicating that the person has a communicable disease. For example, the update may be an update that provides a test result that indicates the first person has a communicable disease. Alternatively, the update may be the result of a diagnosis by a medical professional that the first person has a communicable disease. Various forms of update are possible. The response analysis unit 104 detects updates using any of the mechanisms described above at block 204.

At block 306, response analysis unit 104 determines actions to be performed (if any), based on the communicable disease and the person's path through the medical facility. Various actions are possible. For example, response analysis unit 104 may indicate that locations along the path taken by the person are not to be accessed by other people until it is deemed safe to do so. Response analysis unit 104 may indicate that an evacuation of the affected area is advisable. Response analysis unit 104 may indicate that the area along the path is to be treated. The treatment may vary depending on whether the area has been evacuated or not. In cases where the area is not evacuated, treatments that do not harm the occupants of the area may be advised. Such treatments may include aerosol or spray treatments or the administration of ultraviolet (UV) light to the area.

The treatment applied to an area along the path of the person having the communicable disease may vary depending on the distance of the area from the person and the type of communicable disease. For example, cases where the person may have had direct contact with objects in the area may require more serious treatment than where areas where the contact was indirect. For instance, sheets may be burned in the case of direct contact, whereas sheets may be washed in cases where contact is indirect. Other examples of treatments include dispensing aerosol disinfectants or installing UV lights along the path that are turned on or off as persons enter or leave the area along the path.

In some embodiments, response analysis unit 104 receives other data in order to determine an appropriate action. For example, data indicating whether particular air vents are open or closed along the path in the medical facility may be used to determine if an area along the path requires treatment.

Individuals in the area along the path of the person having a communicable disease may be queried to determine if the individual would like to receive a treatment for the communicable disease. For example, the individuals may be queried upon exiting a monitored area along the path. A record (e.g., an EMR) can be made of the person's exposure to the communicable disease and their decision on whether or not to accept treatment. Treatments can be administered by medical professionals or automatically dispensed by a machine, and may include pills, liquids, airborne sprays etc.

The depicted flowcharts are provided as an example to aid in understanding embodiments, and should not be used to limit embodiments. Embodiments can perform additional operations, fewer operations, operations in parallel, operation in a different order, etc.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 4 depicts an example computer system. A computer system includes a processor unit 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport®, InfiniBand®, NuBus, etc.), a network interface 405 (e.g., an ATM interface, an Ethernet interface, a Frame Relay interface, SONET interface, wireless interface, etc.), and a storage device(s) 409 (e.g., optical storage, magnetic storage, etc.). The system memory 407 embodies functionality to implement embodiments described above. The system memory 407 may include one or more functionalities(e.g., EMR response analysis unit 410) that facilitate the method of updating EMRs of persons exposed to communicable diseases and methods for performing actions based on a person's path through a medical facility. Any one of these functionalities may be partially (or entirely) implemented in hardware and/or on the processing unit 401. For example, the functionality may be implemented with an application specific integrated circuit, in logic implemented in the processing unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401, the storage device(s) 409, and the network interface 405 are coupled to the bus 403. Although illustrated as being coupled to the bus 403, the memory 407 may be coupled to the processor unit 401.

While the embodiments are described with reference to various implementations and exploitations, it will be understood that these embodiments are illustrative and that the scope of the inventive subject matter is not limited to them. In general, techniques for updating EMRs and performing actions based on a person's path through a facility as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the example configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A computer-implemented method for updating an electronic medical record, the method comprising:
receiving data indicating a common reference point of exchange for a first person and a second person;
detecting an update to an electronic medical record (EMR) of the first person, the update including a diagnosis of a communicable disease;
determining an exposure of the second person to the communicable disease in accordance with the data indicating a common reference point of exchange and the communicable disease; and
automatically updating an EMR of the second person in accordance with the determination of the exposure of the second person to the communicable disease.

2. The method of claim 1, wherein automatically updating the EMR of the second person includes updating the EMR of the second person in accordance with information in the EMR of the second person.

3. The method of claim 1, wherein determining an exposure of the second person to the communicable disease includes determining one or more of an incubation period for the communicable disease, a transmission medium for the communicable disease, or a severity factor for the communicable disease.

4. The method of claim 1, and further comprising performing one or more actions in response to determining an exposure of the second person to the communicable disease, the one or more actions including one or more of ordering medicine for the second person, providing a prescription to the second person, providing information to the second person, scheduling an appointment for the second person, or notifying a third party of the exposure of the second person to the communicable disease.

5. The method of claim 1, wherein the common reference point of exchange includes a location of the first person and the second person, an object handled by the first person and the second person, or a vehicle occupied by the first person and the second person.

6. The method of claim 1, and further comprising:
determining a path of the first person through a medical facility; and
determining an action in accordance with the path and with the communicable disease.

7. The method of claim 6, wherein the action comprises one or more of evacuating an area along the path, treating the area along the path, or offering a treatment for the communicable disease to a second person exiting the area along the path.

8. A computer program product for updating an electronic medical record, the computer program product comprising:
a computer readable storage medium having computer usable program code embodied therewith, the computer usable program code comprising a computer usable program code configured to:
receive data indicating a common reference point of exchange for a first person and a second person;
detect an update to an electronic medical record (EMR) of the first person, the update including a diagnosis of a communicable disease;
determine an exposure of the second person to the communicable disease in accordance with the data indicating a common reference point of exchange and the communicable disease; and
automatically update an EMR of the second person in accordance with the determination of the exposure of the second person to the communicable disease.

9. The computer program product of claim 8, wherein the computer usable program code configured to automatically update the EMR of the second person includes computer usable program code configured to update the EMR of the second person in accordance with information in the EMR of the second person.

10. The computer program product of claim 8, wherein the computer usable program code configured to determine an exposure of the second person to the communicable disease includes the computer usable program code configured to determine one or more of an incubation period for the communicable disease, a transmission medium for the communicable disease, or a severity factor for the communicable disease.

11. The computer program product of claim 8, wherein the computer usable program code is further configured to perform one or more actions in response to determining an exposure of the second person to the communicable disease, the one or more actions including one or more of ordering medicine for the second person, providing a prescription to the second person, providing information to the second person, scheduling an appointment for the second person, or notifying a third party of the exposure of the second person to the communicable disease.

12. The computer program product of claim 8, wherein the common reference point of exchange includes a location of the first person and the second person, an object handled by the first person and the second person, a vehicle occupied by the first person and the second person.

13. The computer program product of claim 8, wherein the computer usable program code is further configured to:
determine a path of the first person through a medical facility; and
determine an action in accordance with the path and with the communicable disease.

14. The computer program product of claim 8, wherein the action comprises one or more of evacuating an area along the path, treating the area along the path, or offering a treatment for the communicable disease to a person exiting the area along the path.

15. An apparatus comprising:
one or more processors; and
a response analysis unit executable by the one or more processors and configured to:
receive data indicating a common reference point of exchange for a first person and a second person;
detect an update to an electronic medical record (EMR) of the first person, the update including a diagnosis of a communicable disease;
determine an exposure of the second person to the communicable disease in accordance with the data indicating a common reference point of exchange and the communicable disease; and
automatically update an EMR of the second person in accordance with the determination of the exposure of the second person to the communicable disease.

16. The apparatus of claim 15, wherein the response analysis unit updates the EMR of the second person in accordance with information in the EMR of the second person.

17. The apparatus of claim 15, wherein the response unit determines one or more of an incubation period for the communicable disease, a transmission medium for the communicable disease, or a severity factor for the communicable disease.

18. The apparatus of claim 15, wherein the response unit is further configured to perform one or more actions in response to determining an exposure of the second person to the communicable disease, the one or more actions including one or more of ordering medicine for the second person, providing a prescription to the second person, providing information to the second person, scheduling an appointment for the second person, or notifying a third party of the exposure of the second person to the communicable disease.

19. The apparatus of claim 15, wherein the common reference point of exchange includes a location of the first person and the second person, an object handled by the first person and the second person, or a vehicle occupied by the first person and the second person.

20. The apparatus of claim 15, and further comprising a location detector, wherein the response analysis unit is further configured to:
receive location data from the location detector;
determine a path of the first person through a medical facility using the location data; and
determine an action in accordance with the path and with the communicable disease.
